(19) United States
(12) Patent Application Publication
(10) Pub. No.: US 2007/0036536 A1
(43) Pub. Date: Feb. 15, 2007

(54) Electronic apparatus with adjustable charge couple device

(76) Inventor: Yin-Hsiang Thy, Taipei (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 11/204,888

(22) Filed: Aug. 15, 2005

(51) Int. Cl. G03B 7/099

(52) U.S. Cl. 396/268

(57) ABSTRACT

An electronic apparatus for taking an image of an object comprises a lens for receiving the image of the object in the form of optical signals, and a converter for converting the optical signals from the lens into electrical signals the converter being adjustable in orientation with respect to the lens.

### BACKGROUND OF THE INVENTION

The present invention generally relates to an electronic apparatus and, more particularly, to a digital camera or digital video camera having an adjustable charge couple device (“CCD”) and a method of operating the same.

Unlike a traditional camera in which an image taken by a lens system is projected onto a film, in a digital camera, an image taken by a lens system is projected onto a charge couple device (“CCD”). FIG. 1 is a functional block diagram of a digital camera 10. Referring to FIG. 1, a digital camera 10 includes a lens system 12, a CCD 14, an analog to digital converter (“ADC”) 16, and a microprocessor unit (“MPU”) 18. The lens system 12 may include a focus detection sensor and a focus lens for taking an image in optical form. The CCD 14, which may include photosensitive elements, converts optical signals provided from the lens system 12 into electrical signals. The electrical signals, in analog form, are converted by the ADC 16 into digital signals. The MPU 18 includes an image compressor 181 for compressing the received digital signals and an image processor 182 for converting the compressed digital signals in a picture format such as JPEG (Joint Photographic Experts Group).

The digital camera 10 further includes an on-board or built-in memory 22, a removable memory 24 and a display device 26. Pictures provided from the MPU 18 are stored in the built-in memory 22 or removable memory 24, for example, a PC or PCMCIA card, a CF (Compact Flash) card or an SM (Smart Media) card. A user of the digital camera 10 may view the pictures through the display device 26, for example, a liquid crystal display (“LCD”), or display the pictures on a PC or TV. Generally, the CCD 14 of the digital camera 10 is immobile with respect to the lens system 12. That is, a user of the digital camera 10 is not allowed to move or rotate the CCD 14 with respect to lens system 12 during operation. Likewise, a conventional digital video camera may include a CCD or CMOS (complementary metal oxide semiconductor) sensor for converting optical signals into electrical signals. The CCD or CMOS sensor is also immobile with respect to a lens system even though a digital video camera has a more complicated structure than a digital camera. The immobility of a CCD or CMOS sensor may disadvantageously cause inconvenience in photography, which will be discussed in detail by reference to FIGS. 2A to 2E.

FIG. 2A is a schematic diagram illustrating methods of taking pictures at different locations or directions. FIGS. 2B, 2C, 2D and 2E are schematic diagrams illustrating images taken at the different locations or directions shown in FIG. 2A. Referring to FIG. 2A, a location labeled with b in front of a center part of an object 30 by a distance d₁ is assumed to be the best photo-shooting location. FIG. 2B shows an image taken at the location b at a straight angle. Referring to FIG. 2B, the whole of object 30 is taken with moderate margins.

In some cases, however, the best photo-shooting location may happen to be in a lake, blocked by trees or rocks, or may have been preoccupied by a crowd. A second best location e₁ in front of object 30 near a first side part 32 thereof separated by the distance d₁ may therefore become an actual photo-shooting location. FIG. 2C shows an image taken at the location e₁ at a straight angle in a direction n, approximately normal to object 30. Referring to FIG. 2C, a second side part 34 of object 30 is truncated, i.e., only a part of object 30 including first side part 32 is taken, resulting in a severe margin issue.

To alleviate the truncation issue, one may step backward from the location e₁ to a location e₂ in front of object 30 near first side part 32 separated by a distance d₂. FIG. 2D shows an image taken at the location e₂ at a straight angle in the direction n. Referring to FIG. 2D, the truncation issue is eliminated. However, since the distance d₂ is greater than d₁, the image of object 30 in FIG. 2D is smaller than that in FIG. 2B. Moreover, the margin issue may become worse.

To alleviate the truncation issue, alternatively, one may stay at the location e₁ and take a picture of object 30 from a direction F instead of the direction n. FIG. 2E shows an image taken at the location e₁ at a straight angle in the direction F. Referring to FIG. 2E, the truncation issue is eliminated. However, the margin issue is not alleviated and, what even worse, an optical distortion issue may occur, where a close end 32 of object 30 appears larger than a remote end 34. The optical distortion issue, which may be worse with digital cameras or digital video cameras than with traditional ones, will be further discussed below by reference to FIGS. 3A to 3E.

FIG. 3A is a schematic diagram illustrating methods of taking pictures at different locations or elevations. FIGS. 3B, 3C, 3D and 3E are schematic diagrams illustrating images taken at the different locations or elevations shown in FIG. 3A. Referring to FIG. 3A, at a first location P₁ at a distance D₁ from an object 40, images are assumed to be best taken from a point B at a first elevation. FIG. 3B shows an image taken at the point B at a straight angle. Referring to FIG. 3B, the whole of object 40 is taken with moderate margins.

In cases that the point B is not accessible, points E₁ and C at different elevations from the first elevation at first location P₁, or a point E₂ at the first elevation at a second location P₂ at a distance D₂ from the object 40 may be taken into consideration. FIG. 3C shows an image taken at the point E₁ at a straight angle, in which a lower part 44 of object 40 is truncated, disadvantageously resulting in undesired margins. FIG. 3D shows an image taken at the point E₂ at a straight angle, where the truncation issue is eliminated at the cost of a smaller image. Moreover, the margin issue may not have been alleviated. FIG. 3E shows an image taken at the point C at an angle of depression. Referring to FIG. 3E, the truncation issue is eliminated at the cost of an optical distortion, where an upper part 42 of object 40 appears larger than lower part 44. Moreover, the margin issue may not have been alleviated.

It is therefore desirable to have a digital camera or digital video camera including an adjustable CCD or CMOS sensor, which is movable or rotatable with respect to a lens system, for eliminating both the truncation issue and margin issue without generating optical distortion.

### BRIEF SUMMARY OF THE INVENTION

The present invention is directed to an electronic apparatus and a method of operating the same that obviate one or more problems resulting from the limitations and disadvantages of the prior art.

In accordance with an embodiment of the present invention, there is provided an electronic apparatus for taking an image of an object that comprises a lens for receiving the image of the object in the form of optical signals, and a converter for converting the optical signals from the lens into electrical signals, the converter being adjustable in orientation with respect to the lens.

Also in accordance with the present invention, there is provided an electronic apparatus for taking an image of an object that comprises a lens for receiving the image of the object in the form of optical signals, and a converter for converting the optical signals from the lens into electrical signals, the converter being movable with respect to the lens in a direction.

Further in accordance with the present invention, there is provided an electronic apparatus for taking an image of an object that comprises a lens for receiving the image of the object in the form of optical signals, and a converter for converting the optical signals from the lens into electrical signals, the converter being rotatable with respect to the lens around an axis.

Still in accordance with the present invention, there is provided a method for taking an image of an object that comprises providing an electronic apparatus including a lens and a converter for converting optical signals from the lens into electrical signals, the converter being adjustable in orientation with respect to the lens, positioning the electronic apparatus at a point in front of the object including a first part and a second part away from the first part, directing the lens toward the first part of the object at the point such that the first part is accessible by the lens while the second part is not accessible by the lens, and adjusting the converter in orientation with respect to the lens until the second part of the object is accessible by the lens.

Yet still in accordance with the present invention, there is provided a method for taking an image of an object that comprises providing an electronic apparatus including a lens and a converter for converting optical signals from the lens into electrical signals, the converter being movable in a direction with respect to the lens, positioning the electronic apparatus at a location in front of the object including a first side and a second side away from the first side, directing the lens toward the first side of the object at the location such that the first side is accessible by the lens while the second side is not accessible by the lens, and moving the converter in the direction with respect to the lens until the second side of the object is accessible by the lens.

Further still with the present invention, there is provided a method for taking an image of an object that comprises providing an electronic apparatus including a lens and a converter for converting optical signals from the lens into electrical signals, the converter being rotatable with respect to the lens around an axis, positioning the electronic apparatus at an elevation in front of the object including an upper side and a lower side away from the upper side, directing the lens toward the upper side of the object at the elevation such that the upper side is accessible by the lens while the lower side is not accessible by the lens, and rotating the converter with respect to the lens around the axis until the lower side of the object is accessible by the lens.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a functional block diagram of a digital camera;

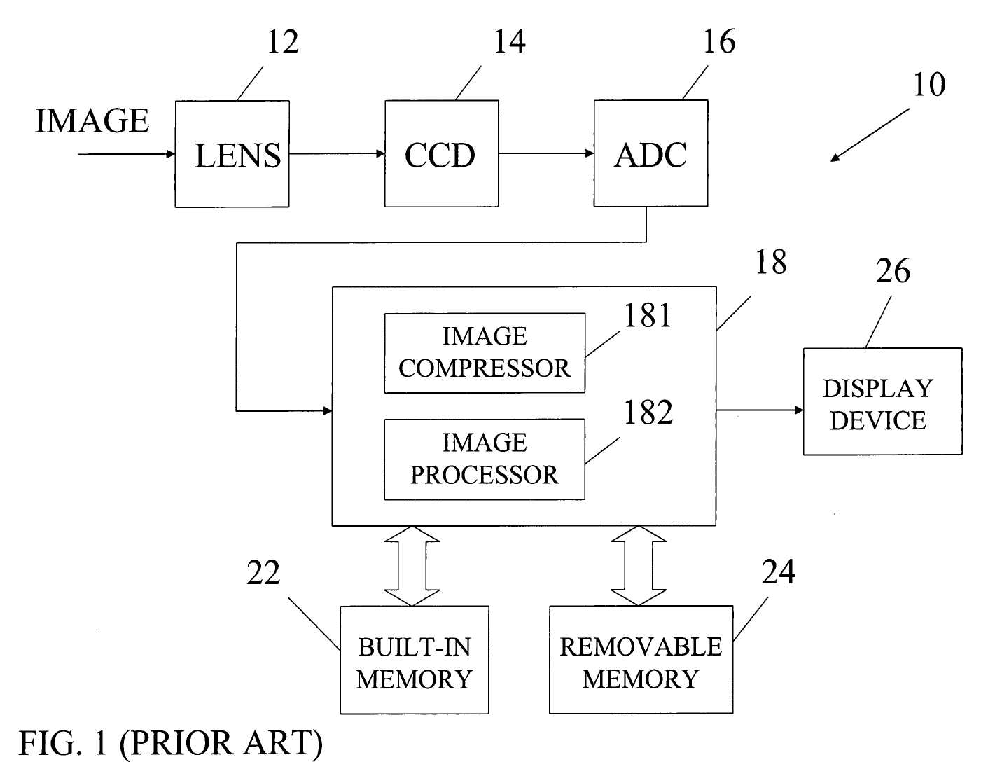

FIG. 2A is a schematic diagram illustrating methods of taking pictures at different locations or angles;

FIGS. 2B, 2C, 2D and 2E are schematic diagrams illustrating images taken at the different locations or angles shown in FIG. 2A;

FIG. 3A is a schematic diagram illustrating methods of taking pictures at different locations or elevations;

FIGS. 3B, 3C, 3D and 3E are schematic diagrams illustrating images taken at the different locations or elevations shown in FIG. 3A;

FIG. 4A is a schematic diagram of an adjustable charge couple device (“CCD”) in accordance with one embodiment of the present invention;

FIG. 4B is a schematic diagram illustrating a method for operating the adjustable CCD shown in FIG. 4A;

FIG. 5A is a schematic diagram of an adjustable CCD in accordance with another embodiment of the present invention;

FIG. 5B is a schematic diagram illustrating a method for operating the adjustable CCD shown in FIG. 5A;

FIG. 6 shows a structure of an adjusting system for adjusting a CCD in accordance with one embodiment of the present invention;

FIG. 7A is a schematic diagram of an adjustable CCD in accordance with yet another embodiment of the present invention;

FIG. 7B is a schematic diagram illustrating a method for operating the adjustable CCD shown in FIG. 7A;

FIG. 8A is a schematic diagram of an adjustable CCD in accordance with still another embodiment of the present invention;

FIG. 8B is a schematic diagram illustrating a method for operating the adjustable CCD shown in FIG. 8A; and

FIG. 9 shows a structure of an adjusting system for adjusting a CCD in accordance one embodiment of the present invention.

### DETAILED DESCRIPTION OF THE INVENTION

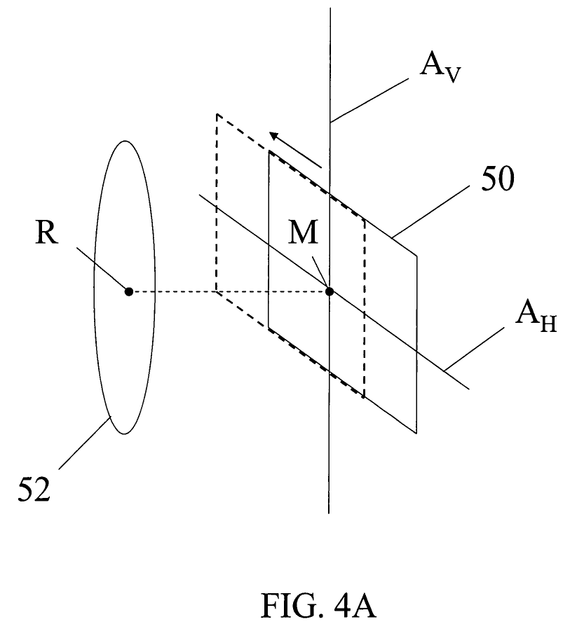

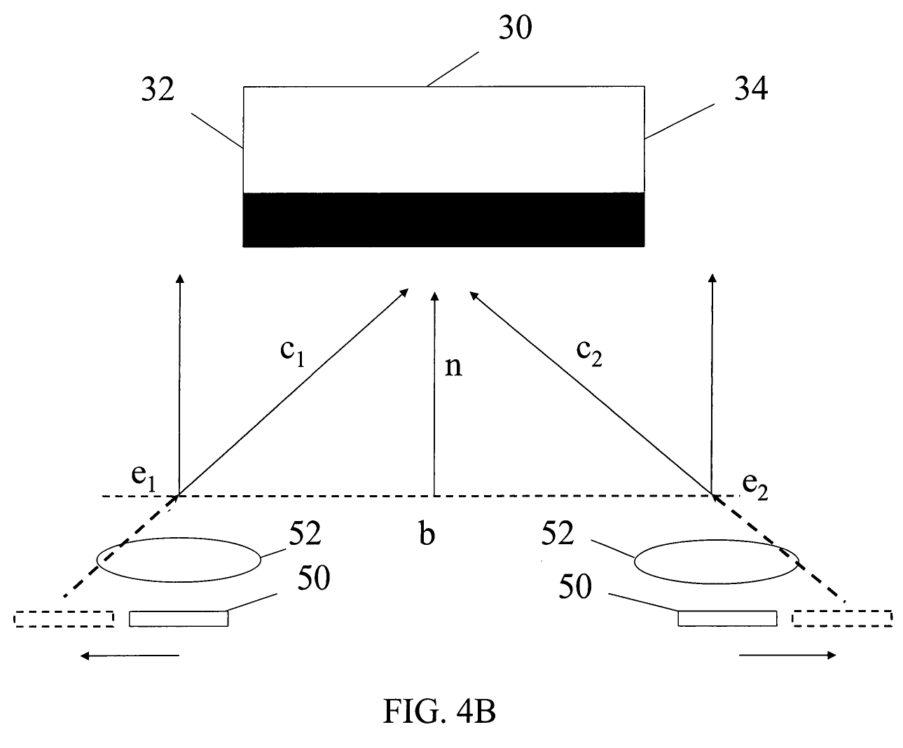

FIG. 4A is a schematic diagram of an adjustable charge couple device (“CCD”) 50 in accordance with a preferred embodiment of the present invention. Referring to FIG. 4A, adjustable CCD 50 includes a geometric center M corresponding to a geometric center R of a lens 52 in an electronic apparatus (not shown) such as a digital camera or digital video camera. Center M is the intersection point of a pair of axes A_{H} and A_{V}, which are orthogonal to one another. Adjustable CDD 50 is movable in a horizontal direction with respect to lens 52. Specifically, adjustable CCD 50 is movable along the horizontal axis A_{H} during operation.

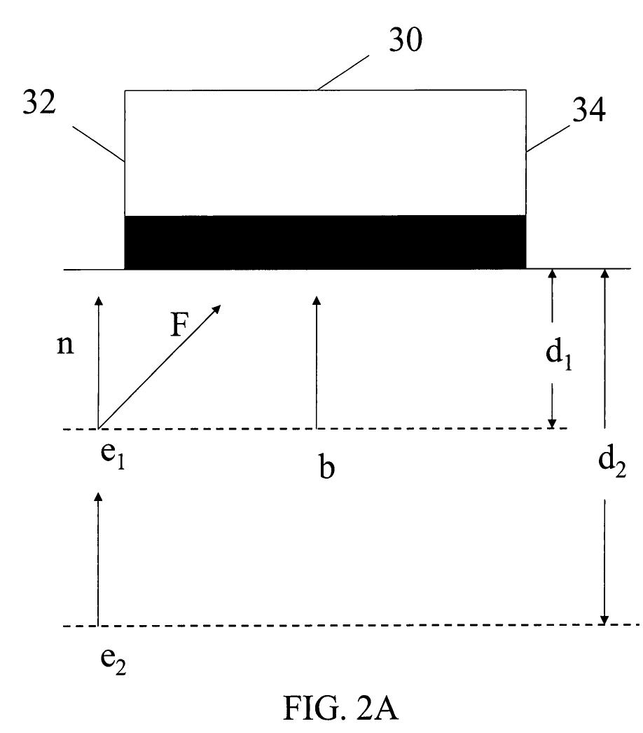

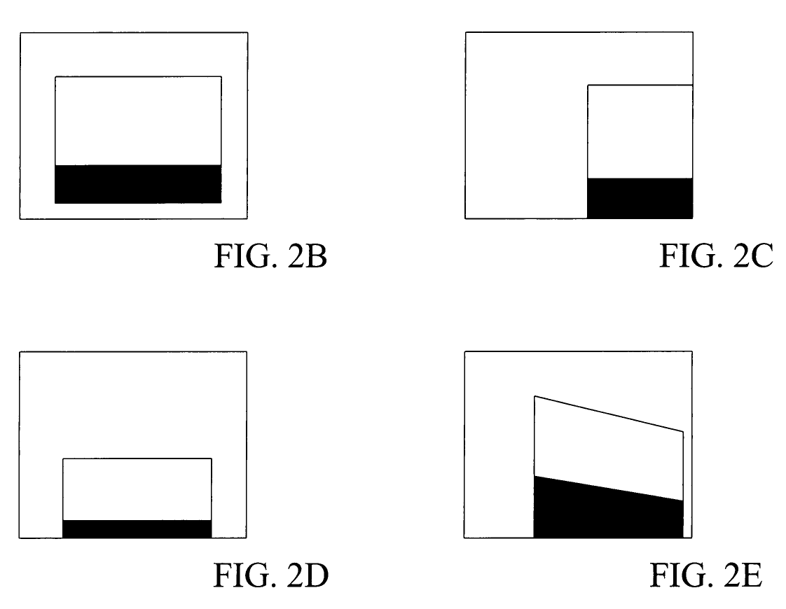

FIG. 4B is a schematic diagram illustrating a method for operating the adjustable CCD 50 shown in FIG. 4A. Referring to FIG. 4B, at location e₁, where the truncation issue may occur, lens 52 is directed at a straight angle toward first side 32 of object 30 in a normal direction n. The CCD 50 is then adjusted to move leftward, i.e., away from first side 32, in a horizontal direction with respect to lens 52, approximately orthogonal to the normal direction n. Adjustable CCD 50 is moved until the lens 52 and CCD 50 are aligned in a direction, for example, direction c₁, where the whole of the object 30 or at least a majority of the object 30 is in the camera's viewing range. As a result, the camera functions as if the lens 52 was directed in the direction c₁ without adjusting the CCD 50. Since the lens 52 is held at a straight angle in the normal direction n, the optical distortion issue is prevented. Furthermore, since the CCD 50, together with the lens 52, is directed in the direction c₁, the truncation issue is prevented. An image taken in accordance with the present method is similar to that shown in FIG. 2B, i.e., taken at the best location b.

Likewise, at location e₂, where the truncation issue may occur, the lens 52 is directed at a straight angle toward second side 34 of the object 30 in the normal direction n. The CCD 50 is then adjusted to move rightward, i.e., away from second side 34, in a horizontal direction with respect to the lens 52, approximately orthogonal to the normal direction n. The adjustable CCD 50 is moved until the lens 52 and the CCD 50 are aligned in a direction c₂. As a result, the camera functions as if the lens 52 was directed in the direction c₂ without adjusting the CCD 50. Since the lens 52 is held at a straight angle in the normal direction n, the optical distortion issue is prevented. Furthermore, since the CCD 50, together with the lens 52, is directed in the direction c₂, the truncation issue is prevented. An image taken in accordance with the present method is similar to that shown in FIG. 2B.

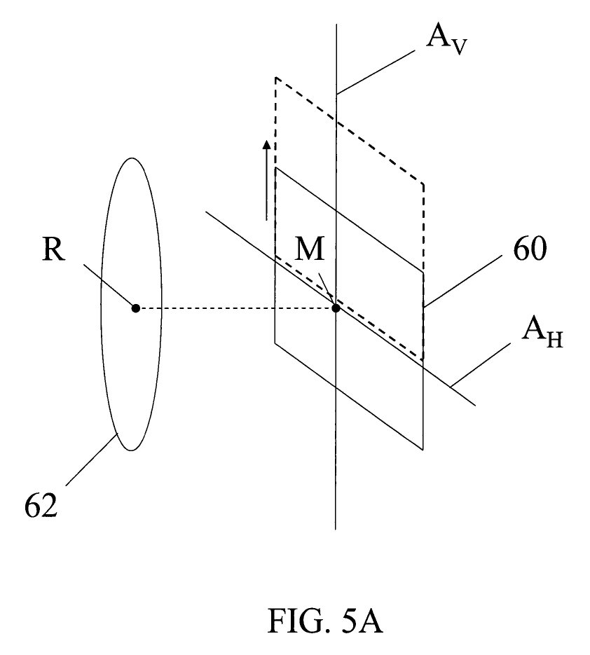

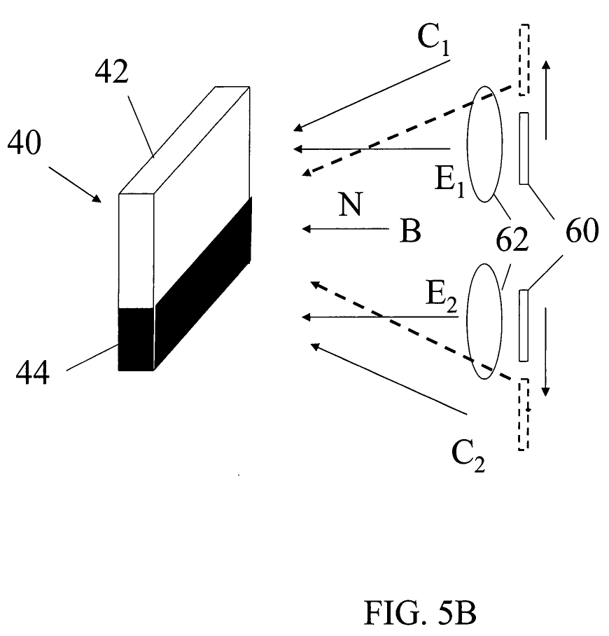

FIG. 5A is a schematic diagram of an adjustable CCD 60 in accordance with another preferred embodiment of the present invention. Referring to FIG. 5A, the adjustable CCD 60 includes a similar structure to the adjustable CCD 50 shown in FIG. 4A, except that the adjustable CDD 60 is movable in a vertical direction with respect to a lens 62. Specifically, the adjustable CCD 60 is movable along the vertical axis A_{V} during operation.

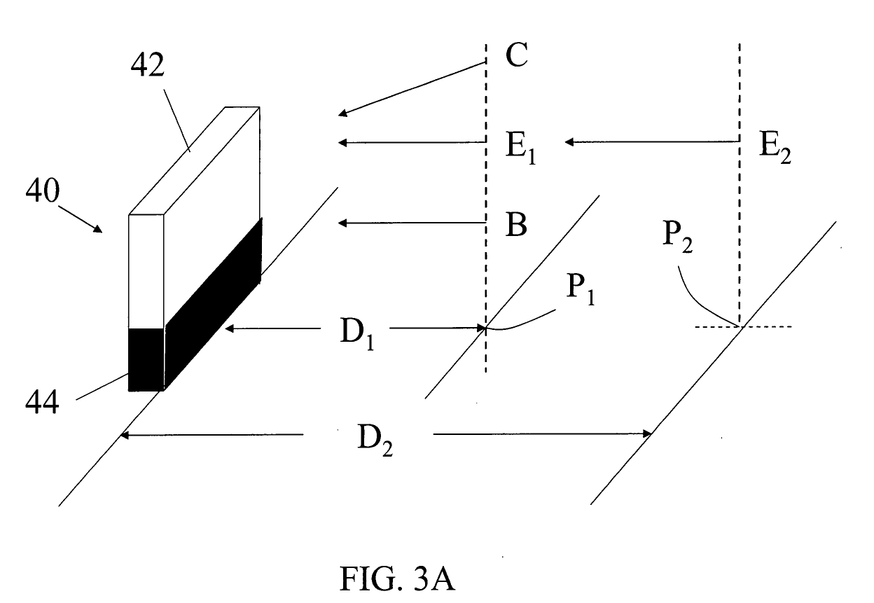

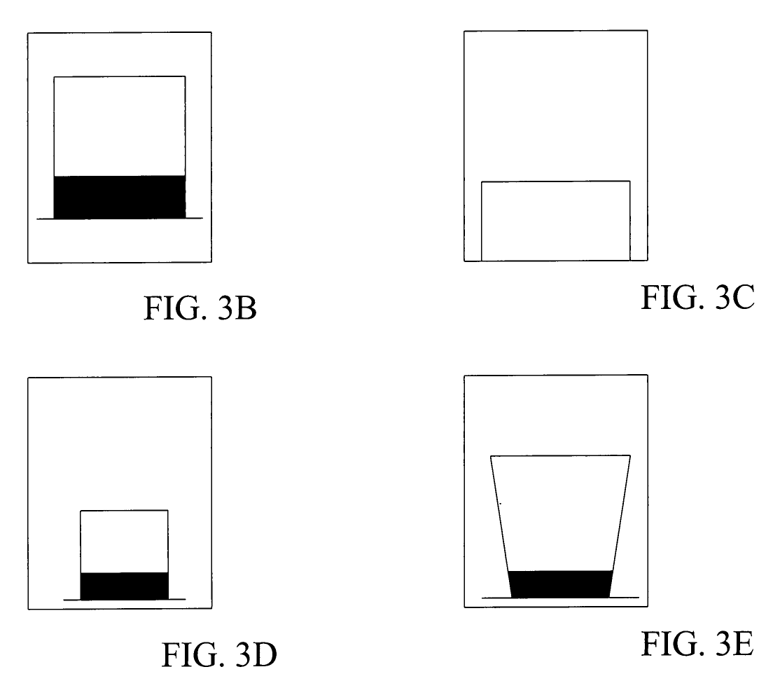

FIG. 5B is a schematic diagram illustrating a method for operating adjustable CCD 60 shown in FIG. 5A. Referring to FIG. 5B, at a first elevation E₁, where the truncation issue may occur, the lens 62 is directed at a straight angle toward the upper part 42 of the object 40 in a normal direction N. The CCD 60 is then adjusted to move upwardly, i.e., away from the upper part 42, in a vertical direction with respect to the lens 62, approximately orthogonal to the normal direction N. The adjustable CCD 60 is moved until the lens 62 and the CCD 60 are aligned in a direction C₁. As a result, the camera functions as if the lens 62 was directed in the direction C₁ at an angle of depression without adjusting the CCD 60. Since the lens 62 is held at a straight angle in the normal direction N, the optical distortion issue is prevented. Furthermore, since the CCD 60, together with the lens 62, is directed in the direction C₁, the truncation issue is prevented. An image taken in accordance with the present method is similar to that shown in FIG. 3B, i.e., taken at the best elevation B.

Likewise, at a second elevation E₂, where the truncation issue may occur, the lens 62 is directed at a straight angle toward the lower part 44 of the object 40 in a normal direction N. The CCD 60 is then adjusted to move downwardly, i.e., away from the lower part 44, in a vertical direction with respect to the lens 62, approximately orthogonal to the normal direction N. The adjustable CCD 60 is moved until lens 62 and the CCD 60 are aligned in a direction C₂. As a result, the camera functions as if the lens 62 was directed in the direction C₂ at an angle of elevation without adjusting the CCD 60. Since the lens 62 is held at a straight angle in the normal direction N, the optical distortion issue is prevented. Furthermore, since the CCD 60, together with the lens 62, is directed in the direction C₂, the truncation issue is prevented. An image taken in accordance with the present method is similar to that shown in FIG. 3B.

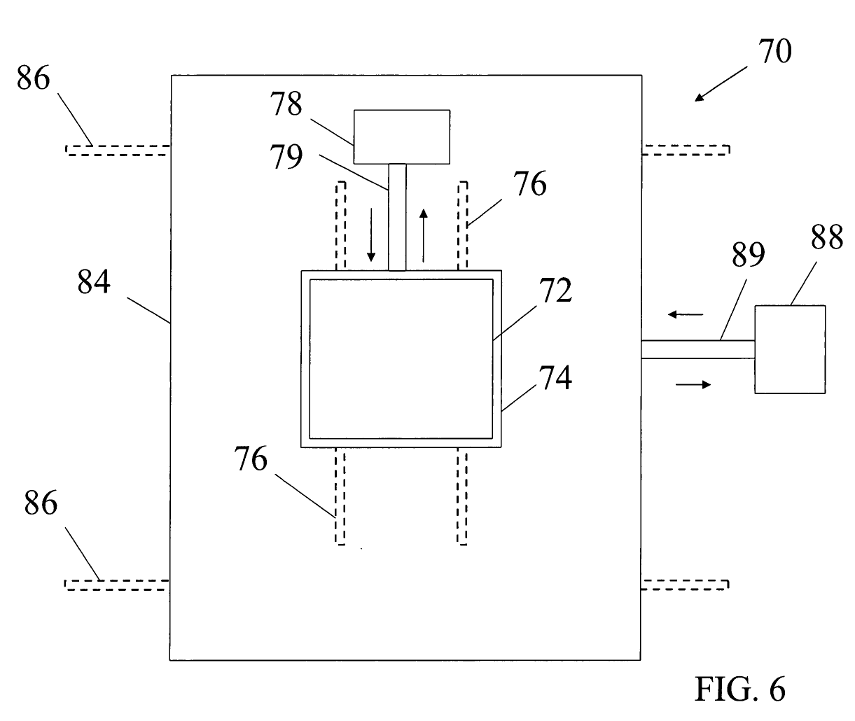

FIG. 6 shows a structure of an adjusting system 70 for adjusting a CCD 72 in accordance with a preferred embodiment of the present invention. Referring to FIG. 6, the adjusting system 70 includes a first plate 74 and a second plate 84. The CCD 72 is mounted on the first plate 74, which in turn is mounted on the second plate 84. The first plate 74 is movable in either direction along a pair of first rails 76. A first motor 78 provides a force through a first transmission device 79 to control the movement of the first plate 74 along the pair of first rails 76. In one embodiment according to the present invention, the first motor 78 includes a step motor, and the first transmission device 79 includes a screw.

The second plate 84, on which the first plate 74 and in turn the CCD 72 are mounted, is movable in either direction along a pair of second rails 86 approximately orthogonal to the first rails 76. A second motor 88 provides a force through a second transmission device 89 to control the movement of the second plate 84 along the pair of second rails 86. In one embodiment according to the present invention, the second motor 88 includes a step motor, and the second transmission device 89 includes a screw.

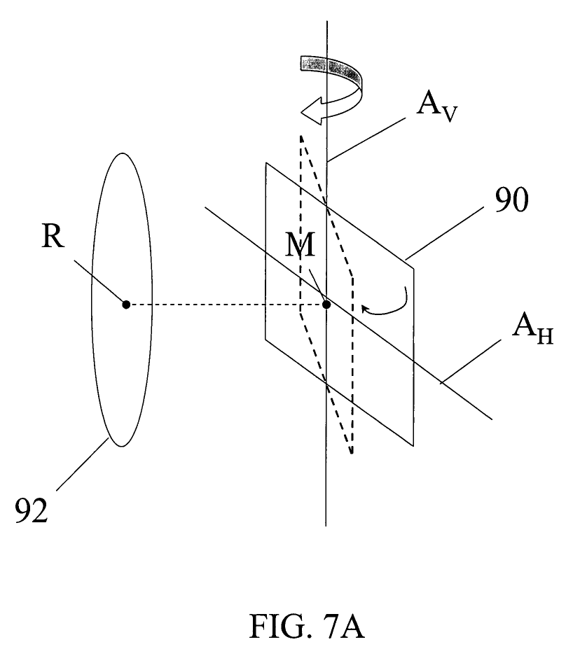

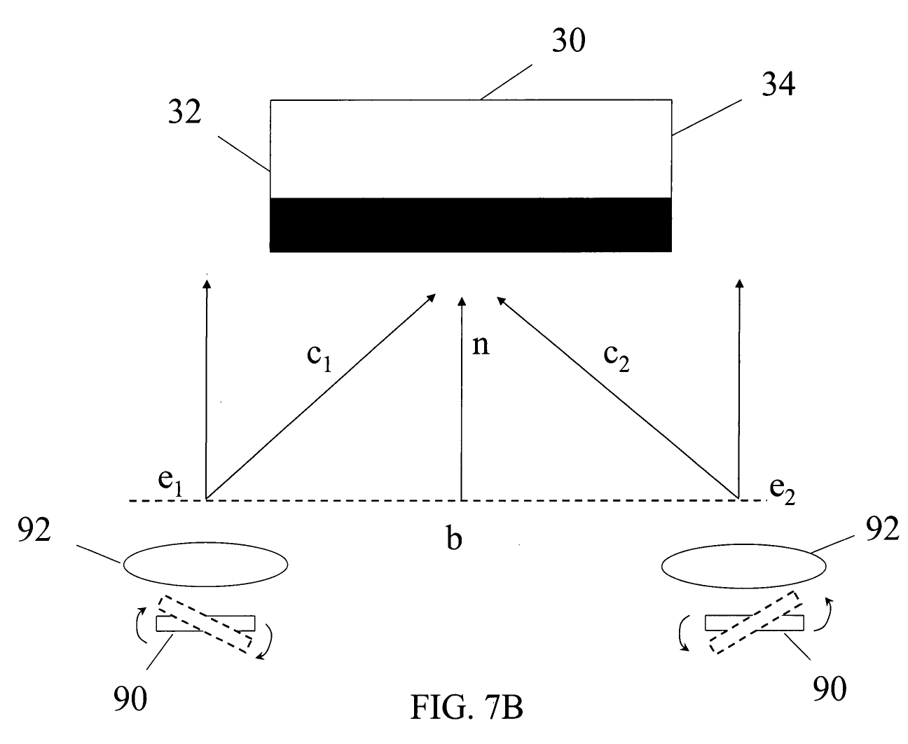

FIG. 7A is a schematic diagram of an adjustable CCD 90 in accordance with yet another preferred embodiment of the present invention. Referring to FIG. 7A, the adjustable CCD 90 includes a geometric center M corresponding to a geometric center R of a lens 92 in an electronic apparatus (not shown) such as a digital camera or digital video camera. The center M is the intersection point of a pair of axes A_{H} and A_{V}, which are orthogonal to one another. The adjustable CDD 90 is rotatable with respect to lens the 92. Specifically, the adjustable CCD 90 is rotatable around the vertical axis A_{V} during operation.

FIG. 7B is a schematic diagram illustrating a method for operating the adjustable CCD 90 shown in FIG. 7A. Referring to FIG. 7B, at location e₁, where the truncation issue may occur, the lens 92 is directed at a straight angle toward the first side 32 of the object 30 in a normal direction n. The CCD 90 is then adjusted to rotate clockwise with respect to the lens 92 around the vertical axis Av. The adjustable CCD 90 is rotated until the lens 92 and the CCD 90 are aligned in a direction, for example, direction c₁, where the whole of the object 30 or at least a majority of the object 30 is in the camera's viewing range. As a result, the camera functions as if the lens 92 was directed in the direction c₁ without adjusting the CCD 90. Since the lens 92 is held at a straight angle in the normal direction n, the optical distortion issue is prevented. Furthermore, since the CCD 90, together with the lens 92, is directed in the direction c₁, the truncation issue is prevented. An image taken in accordance with the present method is similar to that shown in FIG. 2B.

Likewise, at location e₂, where the truncation issue may occur, the lens 92 is directed at a straight angle toward the second side 34 of the object 30 in the normal direction n. The CCD 90 is then adjusted to rotate counterclockwise with respect to the lens 92 around the vertical axis Av. The adjustable CCD 90 is rotated until the lens 92 and the CCD 90 are aligned in a direction c₂. As a result, the camera functions as if the lens 92 was directed in the direction c₂ without adjusting the CCD 90. Since the lens 92 is held at a straight angle in the normal direction n, the optical distortion issue is prevented. Furthermore, since the CCD 90, together with the lens 92, is directed in the direction C₂, the truncation issue is prevented. An image taken in accordance with the present method is similar to that shown in FIG. 2B.

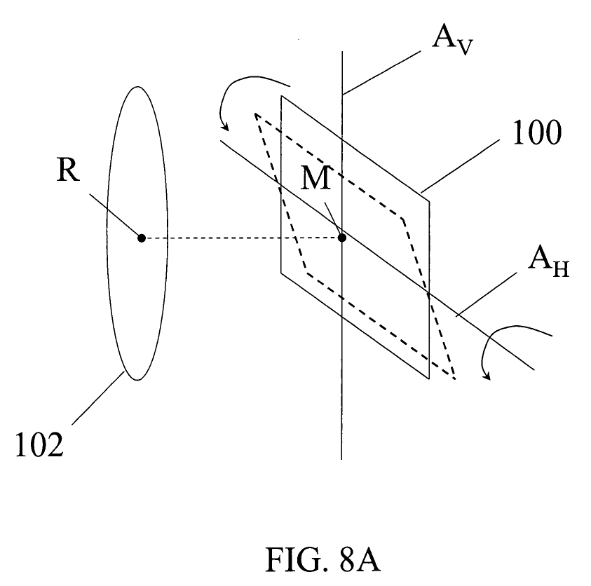

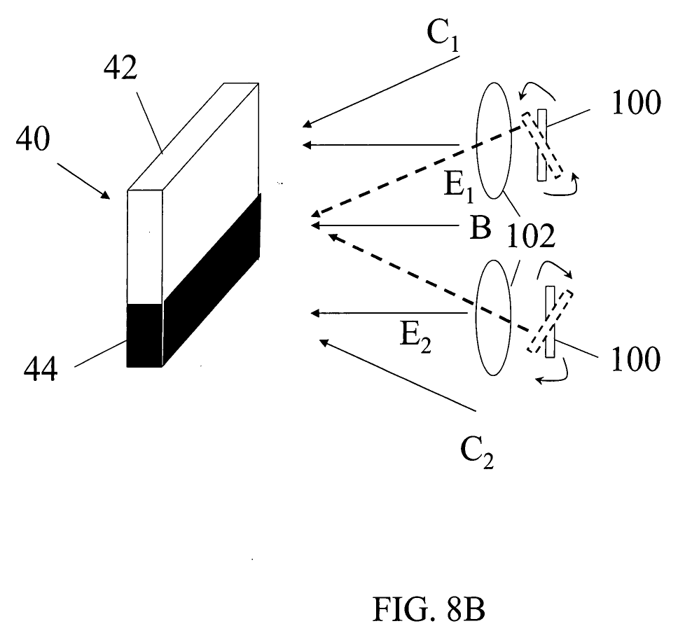

FIG. 8A is a schematic diagram of an adjustable CCD 100 in accordance with still another preferred embodiment of the present invention. Referring to FIG. 8A, the adjustable CCD 100 includes a geometric center M corresponding to a geometric center R of a lens 102 in an electronic apparatus (not shown) such as a digital camera or digital video camera. The center M is the intersection point of a pair of axes A_{H} and A_{V}, which are orthogonal to one another. The adjustable CDD 100 is rotatable with respect to the lens 102. Specifically, the adjustable CCD 100 is rotatable around the horizontal axis A_{H} during operation

FIG. 8B is a schematic diagram illustrating a method for operating the adjustable CCD 100 shown in FIG. 8A. Referring to FIG. 8B, at a first elevation E₁, where the truncation issue may occur, the lens 102 is directed at a straight angle toward the upper part 42 of the object 40 in a normal direction N. The CCD 100 is then adjusted to rotate counterclockwise with respect to the lens 102 around the horizontal axis A_{H}. The adjustable CCD 100 is rotated until the lens 102 and the CCD 100 are aligned in a direction C₁. As a result, the camera functions as if the lens 102 was directed in the direction C₁ at an angle of depression without adjusting the CCD 100. Since the lens 102 is held at a straight angle in the normal direction N, the optical distortion issue is prevented. Furthermore, since the CCD 100, together with the lens 102, is directed in the direction C₁, the truncation issue is prevented. An image taken in accordance with the present method is similar to that shown in FIG. 3B, i.e., taken at the best elevation B.

Likewise, at second elevation E₂, where the truncation issue may occur, the lens 102 is directed at a straight angle toward the lower part 44 of the object 40 in a normal direction N. The CCD 100 is then adjusted to rotate clockwise with respect to the lens 102 around the horizontal axis A_{H}. The adjustable CCD 100 is rotated until the lens 102 and the CCD 100 are aligned in a direction C₂. As a result, the camera functions as if the lens 102 was directed in the direction C₂ at an angle of elevation without adjusting the CCD 100. Since the lens 102 is held at a straight angle in the normal direction N, the optical distortion issue is prevented. Furthermore, since the CCD 100, together with the lens 102, is directed in the direction C₂, the truncation issue is prevented. An image taken in accordance with the present method is similar to that shown in FIG. 3B.

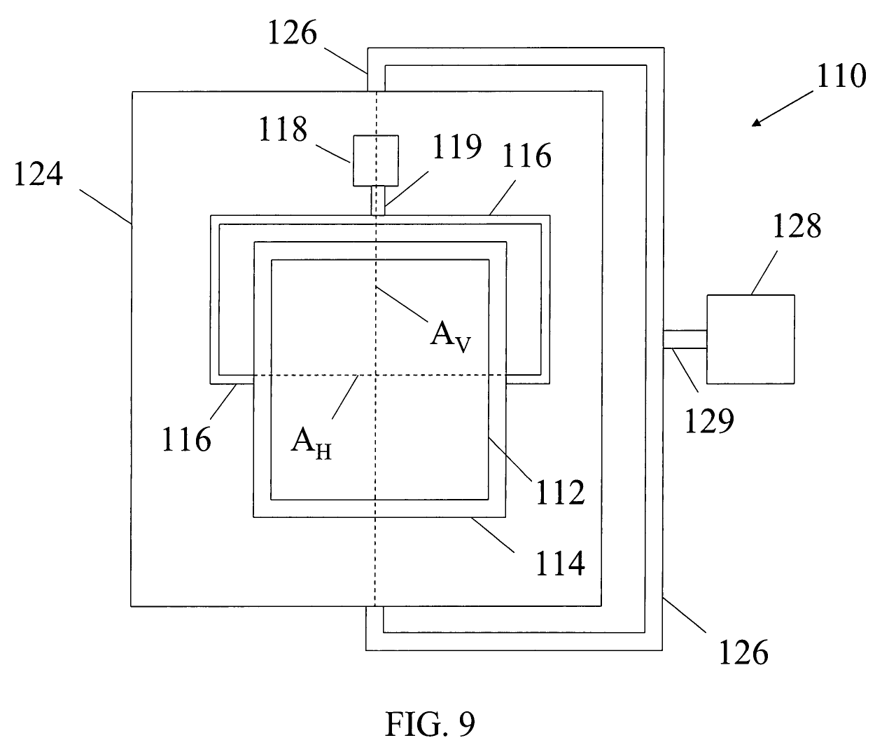

FIG. 9 shows a structure of an adjusting system 110 for adjusting a CCD 112 in accordance one embodiment of the present invention. Referring to FIG. 9, the adjusting system 110 includes a first plate 114 and a second plate 124. The CCD 112 is mounted on the first plate 114, which in turn is mounted on the second plate 124. The first plate 114 is pivoted against a pair of first arms 116, which define a first axis A_{H} (shown in dotted line) around which the first plate 114 is rotatable. A first motor 118 provides a force through a first transmission device 119 to control the rotation of the first plate 114. The second plate 124, on which the first plate 114 and in turn the CCD 112 are mounted, is pivoted against a pair of second arms 126, which define a second axis A_{V} (shown in dotted line) around which the second plate 124 is rotatable. The first axis A_{H} and the second axis A_{V} are approximately orthogonal to one another. A second motor 128 provides a force through a second transmission device 129 to control the rotation of the second plate 124.

It will be appreciated by those skilled in the art that changes could be made to the embodiments described above without departing from the broad inventive concepts thereof. It is understood, therefore, that this invention is not limited to the particular embodiments disclosed, but it is intended to cover modifications within the spirit and scope of the present invention as defined by the appended claims.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

I claim:

1. An electronic apparatus for taking an image of an object, comprising:
a lens for receiving the image of the object in the form of optical signals; and
a converter for converting the optical signals from the lens into electrical signals, the converter being adjustable in orientation with respect to the lens.

2. The electronic apparatus according to claim 1, wherein the converter includes one of a charge couple device (“CCD”) and a complementary metal-oxide-semiconductor (“CMOS”) sensor.

3. The electronic apparatus according to claim 1, wherein the converter is adjustable by being movable along an axis with respect to the lens.

4. The electronic apparatus according to claim 3, wherein the converter is movable along a different axis approximately orthogonal to the axis.

5. The electronic apparatus according to claim 1, wherein the converter is adjustable by being rotatable with respect to the lens around an axis.

6. The electronic apparatus according to claim 5, wherein the converter is rotatable with respect to the lens around a different axis approximately orthogonal to the axis.

7. The electronic apparatus according to claim 1, further comprising:
a first plate on which the converter is mounted, the first plate being movable in a first direction; and
a second plate on which the first plate is mounted, the second plate being movable in a second direction approximately orthogonal to the first direction.

8. The electronic apparatus according to claim 7, further comprising:
a first motor for providing a force to move the first plate; and
a second motor for providing a force to move the second plate.

9. The electronic apparatus according to claim 1, further comprising:
a first plate on which the converter is mounted being rotatable around a first axis; and
a second plate on which the first plate is mounted being rotatable around a second axis approximately orthogonal to the first axis.

10. The electronic apparatus according to claim 9, further comprising:
a first motor for providing a force to rotate the first plate around the first axis; and
a second motor for providing a force to rotate the second plate around the second axis.

11. An electronic apparatus for taking an image of an object, comprising:
a lens for receiving the image of the object in the form of optical signals; and
a converter for converting the optical signals from the lens into electrical signals, the converter being movable with respect to the lens in a direction.

12. The electronic apparatus according to claim 11, wherein the converter includes a geometric center where a pair of axes orthogonal to one another intersect, the converter being movable with respect to the lens along at least one of the pair of axes.

13. An electronic apparatus for taking an image of an object, comprising:
a lens for receiving the image of the object in the form of optical signals; and
a converter for converting the optical signals from the lens into electrical signals, the converter being rotatable with respect to the lens around an axis.

14. The electronic apparatus according to claim 13, wherein the converter includes a geometric center where a pair of axes orthogonal to one another intersect, the converter being rotatable with respect to the lens around one of the axes.

15. A method for taking an image of an object, comprising:
providing an electronic apparatus including a lens and a converter for converting optical signals from the lens into electrical signals, the converter being adjustable in orientation with respect to the lens;
positioning the electronic apparatus at a point in front of the object including a first part and a second part away from the first part;
directing the lens toward the first part of the object at the point such that the first part is accessible by the lens while the second part is not accessible by the lens; and
adjusting the converter in orientation with respect to the lens until the second part of the object is accessible by the lens.

16. The method according to claim 15, further comprising directing the lens toward a first side of the object such that the first side of the object is accessible while a second side of the object is not accessible by the lens.

17. The method according to claim 16, further comprising moving the converter with respect to the lens in a first direction until the second side of the object is accessible by the lens.

18. The method according to claim 17, further comprising moving the converter with respect to the lens in a second direction approximately orthogonal to the first direction.

19. The method according to claim 15, further comprising directing the lens toward an upper side of the object such that the upper side is accessible while a lower side of the object is not accessible by the lens.

20. The method according to claim 19, further comprising rotating the converter with respect to the lens around a first axis until the lower side of the object is accessible by the lens.

21. The method according to claim 20, further comprising rotating the converter with respect to the lens around a second axis approximately orthogonal to the first axis.

22. A method for taking an image of an object, comprising:
providing an electronic apparatus including a lens and a converter for converting optical signals from the lens into electrical signals, the converter being movable in a direction with respect to the lens;
positioning the electronic apparatus at a location in front of the object including a first side and a second side away from the first side;
directing the lens toward the first side of the object at the location such that the first side is accessible by the lens while the second side is not accessible by the lens; and
moving the converter in the direction with respect to the lens until the second side of the object is accessible by the lens.

23. The method according to claim 22, further comprising moving the converter with respect to the lens in a horizontal direction.

24. The method according to claim 23, further comprising moving the converter with respect to the lens in a vertical direction.

25. A method for taking an image of an object, comprising:
providing an electronic apparatus including a lens and a converter for converting optical signals from the lens into electrical signals, the converter being rotatable with respect to the lens around an axis;
positioning the electronic apparatus at an elevation in front of the object including an upper side and a lower side away from the upper side;
directing the lens toward the upper side of the object at the elevation such that the upper side is accessible by the lens while the lower side is not accessible by the lens; and
rotating the converter with respect to the lens around the axis until the lower side of the object is accessible by the lens.

26. The method according to claim 25, further comprising rotating the converter with respect to the lens around a horizontal axis.

27. The method according to claim 26, further comprising rotating the converter with respect to the lens around a vertical axis.
